(19) United States
(12) Patent Application Publication
(10) Pub. No.: US 2007/0045896 A1
(43) Pub. Date: Mar. 1, 2007

(54) Method and apparatus for producing film

(75) Inventors: Akifumi Kato, Kanagawa (JP); Hidekazu Yamazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/513,033

(22) Filed: Aug. 31, 2006

(30) Foreign Application Priority Data
Aug. 31, 2005 (JP) 2005-250568

(51) Int. Cl. B29C 39/14

(52) U.S. Cl. 264/217; 264/216; 425/224

(57) ABSTRACT

A dope is produced from TAC and a mixture solvent whose main compound is dichloromethane. The dope is cast from a casting die onto a casting drum. In an upstream side from the casting die, a decompression chamber having air pipes is provided. The difference from the ordinate pressure to the pressure inside the decompression chamber is −2000 Pa to −10 Pa. An air is fed through the air pipes into the decompression chamber. Thus the pressure fluctuation in the decompression chamber is reduced, and the pressure becomes almost constant in the widthwise direction. Therefore, the entrained air and another air are prevented from entering into the decompression chamber, which makes the shape of the bead of the discharged casting dope stable. When having self-supporting properties, the casting film is peeled as a film from the casting drum and dried to be a TAC film without thickness unevenness.

### BACKGROUND OF THE INVENTION

1. Field of the Invention

The present invention relates to a method and an apparatus for producing a film.

2. Description Related to the Prior Art

A cellulose acylate film is formed from cellulose acylate. For example, cellulose triacetate (hereinafter TAC) film is formed from TAC whose averaged acetylation degree is in the range of 58.0% to 62.5%. The TAC film is used as a film base of a film material, such as a photosensitive material, since having strength and inflammability. Further, the TAC film is excellent in optical isotropy, and therefore used as a protective film in a liquid crystal display whose market becomes larger in recent years.

The TAC film is usually produced by a solution casting method, in which the produced film is more excellent in physical properties such as optical properties and the like than other film production method such as a melt extrusion method and the like. When it is designated to perform the solution casting method, polymer is dissolved in a mixture solvent in which dichloromethane or methyl acylate is the main solvent component, so as to prepare a polymer solution (hereinafter, dope). Further, in order to provide the excellent physical properties for the produced film, the dope is cast from a casting die onto a support continuously running, while a bead of the dope discharged from the casting die is formed between the casting die and the support. Thus a casting film is formed from the dope on the support. When the casting film has a self-supporting property, the casting film is peeled as a wet film from the support and dried to be a film. Thereafter the film is wound up. (cf: Japan Institute of Invention and Innovation (JIII) Journal of Technical Disclosure No. 2001-1745)

In the solution casting method, when the dope is cast from the casting die, a decompression is made by aspirating in an upstream side in a running direction of the support from the bead for stabilizing the formation of the bead. (cf: Japanese Patent Laid-Open Publications No. 2000-210961, 2000-210959, 2002-160241).

However, according to the method of the publication No. 2000-210961, the mechanical accuracies of an aspiration nozzle for the aspiration and a slit of a die lip of a casting die are increased, which causes the higher cost. According to the method of the publication No. 2000-210959, a buffering chamber is disposed in an upstream from the aspiration nozzle, so as to control the pressure in the upstream side from the bead in a predetermined range. However, also in this method, it is necessary to increase the decompression level when the casting speed is made higher. Further, the pressure in the widthwise direction becomes nonuniform and the end of the bead becomes unstable, because of the wind from sides of the bead and an entrained air caused by moving the support. According to the method of the publication 2002-160241, the distance between the support and the aspirator is made smaller. Also in this method, the mechanical accuracy of the aspirator is increased, which causes the higher cost. Further, in order to move the cast surface of the support in a same position, the support is run at high accuracy, which causes the higher cost.

### SUMMARY OF THE INVENTION

An object of the present invention is to provide a method and a apparatus for producing a film, while the thickness unevenness of the film in a lengthwise direction is reduced without using a special apparatus.

In order to achieve the object and the other object, an apparatus for producing a film includes a casting die for casting on a running support a dope containing a polymer and a solvent so as to form a casting film, and a decompression chamber which is disposed in an upstream side of a running direction of the support from the bead so as to be close to the bead and decompresses the upstream area between the bead and the decompression chamber in the upstream side along a width of the bead. Further, the apparatus has an air supplier for supplying an air into the decompression chamber such that a decompression fluctuation in the decompression chamber may be reduced. The apparatus of the present invention further includes a peel roller for peeling the casting film as the film from the support and a drying device for drying the film.

Preferably the decompression chamber has a main body partitioning an inner space to be decompressed from an outer space and an aspirating section for aspirating an inner air in the inner space, and the air supplier has a pipe for guiding the air into the inner space. Particularly preferably, the pipe is at least one of a first air pipe disposed in a middle portion of a widthwise direction of the main body and a second pipe disposed in a side portion of the widthwise direction of the main body. Especially preferably, each of the first and second air pipes has an air outlet of slit-like shape or a circular shape in cross section. Further, a distance L1 from the air outlet to a lip end of the casting die is in the range of 5 mm to 300 mm.

Particularly, a supply volume rate of the air is in the range of 0.01 m³/min to 3 m³/min, and a wind speed of the air is 0.1 m/s to 20 m/s. Further, when a pressure in a downstream area of the running direction of the support from the bead is PD, a pressure in the upstream area is almost constant in the range of (PD-2000)Pa to (PD-10)Pa. Particularly, the polymer is cellulose acylate.

In a method of producing a film of the present invention, a dope containing a polymer and a solvent is cast from a casting die onto a support so as to form a casting film, while the dope forms a bead between the die and the support. A decompression chamber decompresses an upstream area of a running direction of the support from the bead, such that a pressure in the upstream side may be smaller than in a downstream area of a running direction of the support from the bead. The decompression chamber has a main body for partitioning an inner space to be decompressed from an outer space. The air is supplied into the main body during the decompressing so as to reduce a decompression fluctuation in a widthwise direction of the bead. The casting film is peeled as a film from the support, and the film is dried.

Preferably, a wind speed of the air is 0.1 μm/s to 20 m/s, and a supply volume rate of the air is in the range of 0.01 m³/min to 3 m³/min. Further, when a pressure in a downstream area of the running direction of the support from the bead is PD, a pressure in the upstream area is almost constant in the range of (PD-2000)Pa to (PD-10)Pa. Furthermore, the air is supplied into a middle portion in a widthwise direction of the main body.

Preferably the decompression chamber has an aspirating section for aspirating an inner air in the inner space, and the air supplier has a pipe for guiding the air into the inner space. Particularly preferably, the pipe is at least one of a first pipe disposed in a middle portion of a widthwise direction of the main body and a second pipe disposed in a side portion of the widthwise direction of the main body. Especially preferably, each of the first and second pipes has an air outlet of slit-like shape or a circular shape in cross section. Further, a distance L1 from the air outlet to a lip end of the casting die is in the range of 5 mm to 300 mm. Particularly, the polymer is cellulose acylate.

According to the present invention, a dope containing a polymer and a solvent is cast from a casting die onto a running support, so as to form a casting film, a decompression chamber decompresses in an upstream side of the support from the bead such that a pressure in the upstream side of a running direction of the support from the bead may be smaller than in a downstream side of the running direction, and the casting film is peeled as the film from the support. At this time, an air is supplied into the decompression chamber, so as to make the pressure in the decompression chamber uniform. Therefore, a decompression fluctuation in a widthwise direction of the bead is reduced and the thickness unevenness of the produced film is reduced.

Especially, the air is supplied in the middle portion in the widthwise direction of the decompression chamber. Thus the entrained air caused by the running of the support is prevented from entering into the decompression chamber. Further, the air is supplied in both edge side of the decompression chamber, and therefore the air is prevented from entering through both sides into the decompression chamber.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production apparatus for performing the solution casting method of the present invention;

FIG. 2 is a cross-sectional view of the film production apparatus;

FIG. 3 is a vertically sectional view of the film production apparatus;

FIG. 4 is a schematic diagram of a aspiration chamber of the film production apparatus.

### PREFERRED EMBODIMENTS OF THE INVENTION

In followings, the embodiment of the present invention will be described in detail. However, the present invention is not be restricted in the embodiment.

[Raw Materials]

In this embodiment, cellulose acylate is used as a polymer. In the cellulose acylate, triacetyl cellulose (TAC) is especially preferable. As for cellulose triacylate, it is preferable that the degree of substitution of acyl groups for hydrogen atoms on hydroxyl groups of cellulose preferably satisfies all of following formulae (I)-(III).
2.5≦A+B≦3.0 (I)
0≦A≦3.0 (II)
0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1. Therefore if the esterification of all of the hydroxyl groups on 2^{nd}, 3^{rd} and 6^{th} positions are made, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having excellent solubility can be produced. Especially if non-chrorine type organic solvent is used as the solvent, the non-chrorine type organic solvent is excellent in solubility and used for preparing the dope which has low viscosity and filterability.

Cellulose acylate is may be produced from cotton linter or cotton pulp, and preferably cellulose acylate is produced from cotton linter.

In cellulose acylate, the acyl group having at least 2 carbon atoms may be aliphatic group or aryl group, and is not restricted especially. Such cellulose acylate is, for example, alkylcarbonyl ester and alkenylcarbonyl ester of cellulose. Further, there are aromatic carbonyl ester, aromatic alkyl carbonyl ester, or the like, and these compounds may have other substituents. As preferable examples of the compounds, there are propionyl group, butanoyl group, pentanoly group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexanecarbonyl group, oleoyl group, benzoyl group, naphthylcarbonyl group, cinnamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinnamoyl group and the like, and the especially preferable groups are propionyl group and butanoyl group.

As solvent compounds for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. It is to be noted in the present invention that the dope is a polymer solution or dispersion that is obtained by dissolving or dispersing the polymer in the solvent.

The solvent compounds are preferably hydrocarbon halides having 1 to 7 carbon atoms, and especially dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbon atoms, alcohols having 1 to 12 carbon atoms are preferable, and a mixture thereof can be used. Concretely, there is, for example, a mixture of methyl acetate, acetone, methanol, and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

The detail explanation of cellulose acylate is made from [0140] to [0195]) in Japanese Patent Laid-Open Publication No. 2005-104148. The description of this publication is also applied to the present invention. Further, there are for the additive several additive materials (such as the solvent, plasticizer, deterioration inhibitor, UV absorbing agent, optically anisotropic controller, retardation controller, dyne, matting agent, release agent, releasing accelerator and the like), which are described in detail from [0196] to [0516] of Japanese Patent Laid-Open Publication No. 2005-104148.

[Dope Production Method]

The dope is produced from the above raw materials. At first, the solvent is sent from a solvent tank to a mixing tank. Then a necessary amount of TAC contained in the hopper is sent with measuring to the mixing tank. Thereafter, a necessary amount of the additive solution is sent from the additive tank to the mixing tank. Note that the method of feeding the additive is not restricted in this embodiment. For example, if the additive is in the liquid state in the room temperature, it may be fed in the liquid state to the mixing tank 33 without preparing the additive solution. Otherwise, if the additive is in the solid state in the room temperature, it may be fed in the solid state to the mixing tank with use of another hopper. If plural sorts of additive compounds are used, the additive containing the plural additive compounds may be accumulated in the additive tank altogether. Otherwise plural additive tanks may be used so as to contain the respective additive compounds, which are sent through independent pipes to the mixing tank.

In the above explanation, the solvent (which may contain plural solvent compounds), TAC, the additive are sequentially sent to the mixing tank. However, the sending order is not restricted in it. For example, after the necessary amount of TAC is sent with measurement to the mixing tank, the feeding of the preferable amount of the solvent may be performed. Further, it is not necessary that the additive is previously sent in the mixing tank, and they may be added to a mixture of TAC and the solvent.

The mixing tank is provided with a jacket covering over an outer surface of the mixing tank, a first stirrer to be rotated by a motor, and a second stirrer to be rotated by another motor. The first stirrer preferably has an anchor blade, and the second stirrer is preferably an eccentric stirrer of a dissolver type. The inner temperature in the mixing tank is controlled with use of the heat transferring medium flowing in the jacket. The preferable inner temperature is in the range of −10° C. to 55° C. At least one of the first and second stirrers is adequately chosen for performing the rotation. Thus a swelling liquid in which TAC is swollen in the solvent is obtained. Note that the second stirrer may be omitted. However, as in this embodiment, the second stirrer is preferably provided.

The swelling liquid is fed to a heating device. Preferably, the heating device is preferably a pipe with a jacket. Such a heating device dissolves the solid material in the swelling solution under the heating condition without or with pressurization, so as to produce the dope. In followings, the method is called a heat-dissolving method. Note in the performing the heat-dissolving method that the temperature of the swelling solution is 50° C. to 120° C. However, a cool-dissolving method may be performed, in which the swelling solution is cooled to −100° C. to −30° C. The heat-dissolving method and the cool-dissolving method is adequately chosen, the dissolution of TAC to the solvent can be made enough. The polymer solution is fed to the temperature controlling device, so as to control the temperature nearly to the room temperature.

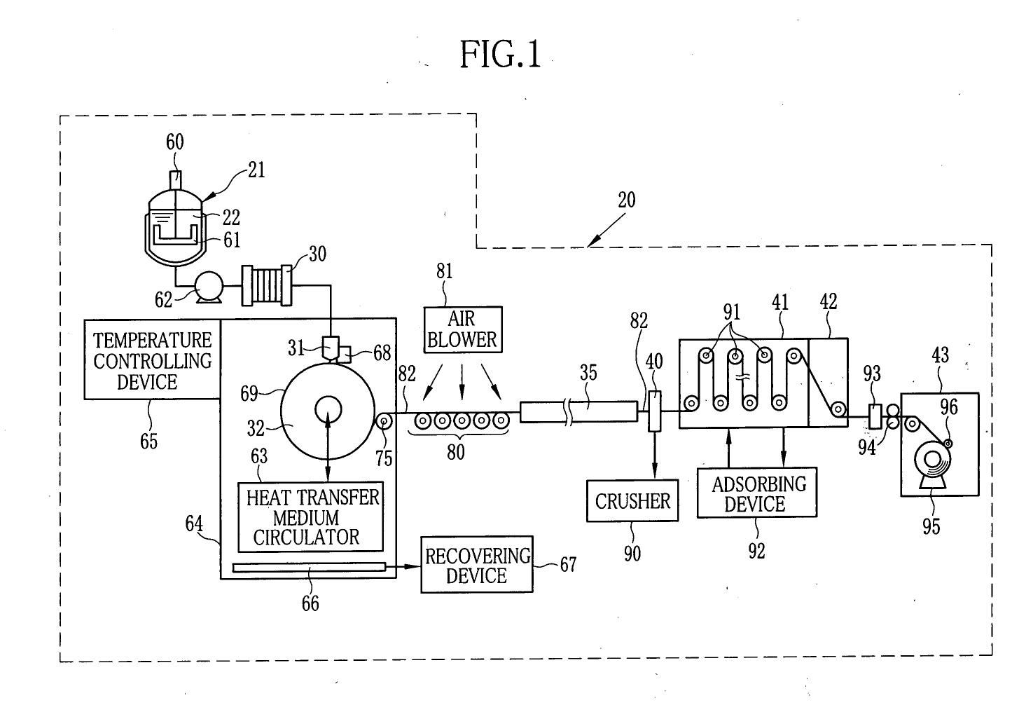

Then the swelling liquid is fed to the filtration device, such that impurities may be removed from the polymer solution. The filter material of the filtration device preferably has an averaged nominal diameter of at most 100 μm. The flow rate of the filtration in the filtration device is preferably at least 50 liter/hr. The swelling solution fed out from the filtration device can be directly sent as a casting dope 22 to the stock tank 21 in a dope production apparatus 20, which are shown in FIG. 1.

In the method in which the dissolution of TAC is performed after the preparation of the swelling liquid, if it is designated that a dope of high concentration is produced, the time for production of such dope becomes longer. Consequently, the production cost becomes higher. Therefore, it is preferable that a dope of the lower concentration than the predetermined value is prepared at first and then the concentrating of the dope is made. In this case, the swelling liquid after the filtration is sent to a flushing device, in which the solvent of the dope is partially evaporated. The solvent vapor generated in the evaporation is condensed by a condenser (not shown) to a liquid state, and recovered by a recovery device. The recovered solvent is recycled by a recycling device and reused. According to this method, the decrease of cost can be designated, since the production efficiency becomes higher and the solvent is reused.

The dope after the concentrating as the above description is extracted from the flushing device through a pump. Further, in order to remove bubbles generated in the dope, it is preferable to perform the bubble removing treatment. As a method for removing the bubble, there are many methods which are already known, for example, an ultrasonic irradiation method and the like. Then the swelling liquid is fed to a filtration device, in which the undissolved materials are removed. Note that the temperature of the dope in a filtration device is preferably in the range of 0° C. to 200° C. The dope after the filtration is stored as the casting dope 22 in the stock tank 21.

Thus a dope produced the produced dope preferably has the TAC concentration in the range of 5 mass % to 40 mass %, particularly 15 mass % to 30 mass %, and especially 17 mass % to 25 mass %. Further, the concentration of the additive (mainly plasticizer) is preferably in the range of 1 mass % to 20 mass %, if the solid content in the casting dope 22 is 100 mass %.

Note that the method of producing the dope is disclosed in detail in [0517] to [0616] in Japanese Patent Laid-Open Publication No. 2005-104148, for example, the dissolution method and the adding methods of the materials, the raw materials and the additive in the solution casting method for forming the TAC film, and the like. The description of the publication can be applied to the present invention.

[Solution Casting Method]

An embodiment of the solution casting method will be described in reference with FIG. 1, now. However, the present invention is not restricted in the embodiment. As shown in FIG. 1, the solution casting instrument 20 includes a stock tank 21, a filtration device 30, a casting die 31, a casting drum 32, a tenter device 35 and the like. Further, in the solution casting instrument 20, there are an edge slitting device 40, a drying chamber 41, a cooling chamber 42, and a winding chamber 43.

In the stock tank 21, a stirrer 61 is attached and rotated by a motor 60. The stock tank 21 is connected through a pump 62 and the filtration device 30 to the casting die 31.

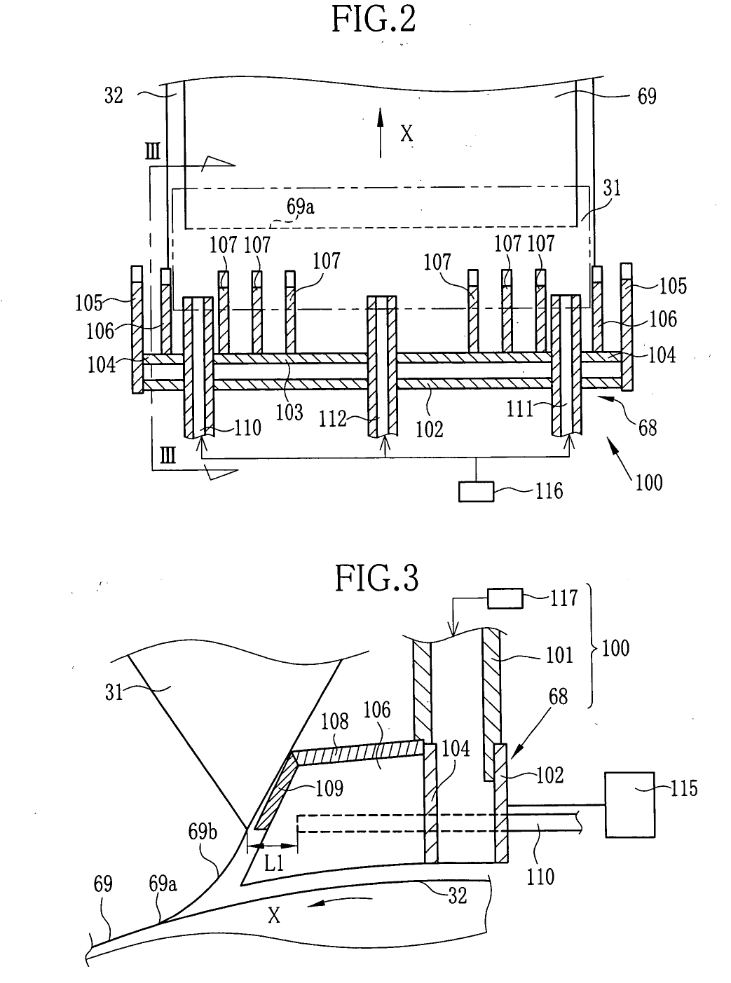

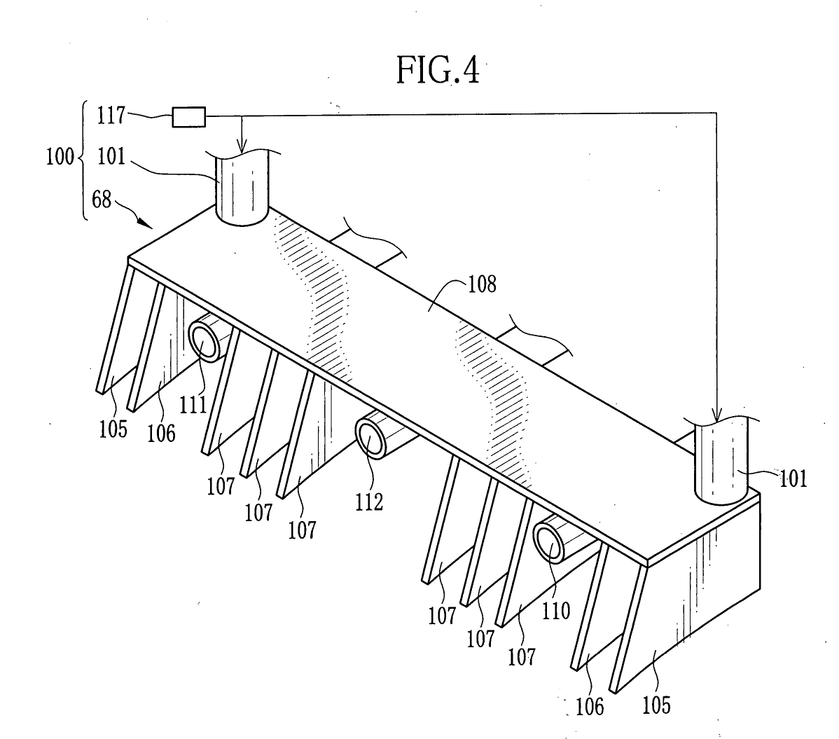

The casting die 31 is used for casting the casting dope 22 onto the casting drum 32 so as to form a casting film 69 on a casting position 69a (see, FIGS. 2 & 3) at which the casting dope 22 get to the casting drum 32. The dope discharged from the casting die 31 forms a bead 69b (see, FIG. 3) of a ribbon-like shape above the casting drum 32.

The materials of the casting die 31 are preferably precipitation hardening stainless steel having a mixture composition of austenite phase and ferrite phase. The preferable material has coefficient of thermal expansion of at most 2×10⁻⁵(° C.⁻¹). Further, the material to be used has an anti-corrosion property, which is almost the same as SUS316, in the examination of forcible corrosion in the electrolyte solution. Preferably, the materials to be used for the casting die 31 has such resistance of corrosion that the pitting doesn't occur on the gas-liquid interface even if the material is dipped in a mixture of dichloromethane, methanol and water for three months. The casting die 31 is preferably manufactured by performing the grinding after a month from the material casting. Thus the surface condition of the casting dope 22 flowing in the casting die 31 is kept uniform. The finish precision of a contact face of the casting die to the casting dope 22 is at most 1 μm in surface roughness and at most 1 μm/m in straightness. The clearance of a slit of the casting die 31, which is an outlet of the casting dope 22, is automatically adjustable in the range of 0.5 mm to 3.5 mm. According to an edge of the contact portion of a lip end of the casting die 31 to the dope, R (R is chamfered radius) is at most 50 μm in all of a width. Further, the shearing rate in the casting die 31 is controlled in the range of 1 to 5000 per second.

A width of the casting die 31 is not restricted especially. However, the width is preferably at least 1.1 times and at most 2.0 times as large as a film width. Furthermore, the casting die 31 is preferably a coat hanger type die. Further, in order to adjust a film thickness, the casting die 31 is preferably provided with an automatic thickness adjusting device. For example, thickness adjusting bolts (heat bolts) are disposed at a predetermined distance in a widthwise direction of the casting die 31. According to the heat bolts, it is preferable that the profile is set on the basis of a predetermined program, depending on feed rate of the pump (preferably, high accuracy gear pump) 62, while the film production is performed. Further, the solution casting instrument 20 may be provided with a thickness gauge (not shown), such as infrared ray thickness gauge and the like. In this case, a clearance of a die lip of the casting die 31 is measured to obtain a data which is called profile, and the feed back control of the adjustment value of the heat bolts may be made by the adjusting program on the base of the profile. The thickness difference between any two points in the widthwise direction except the side edge portions in the casting film 69 is controlled preferably to at most 1 μm. The difference between the maximum and the minimum of the thickness in the widthwise direction is at most 3 μm, and especially at most 2 μm. Further, the accuracy to the designated object value of the thickness is preferably in ±1.5 μm.

Preferably, a hardened layer is preferably formed on a top of a lip end of the casting die 31. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and poor adhesiveness to the casting die 31. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of the casting dope 22 flowing on slit ends of the casting die 31, it is preferable to provide a solvent supplying device (not shown) at the slit ends, on which a gas-liquid interfaces are formed between both edges of the slit and between both edges of the bead 69b and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The supply volume rate to each slit end is preferably in the range of 0.1 mL/min to 1.0 mL/min, in order to prevent the foreign materials from mixing into the casting film 69. Note that the pump for supplying the solvent has a pulse rate (or ripple factor) at most 5%.

Below the casting die 31, the casting drum 32 is disposed, and endlessly rotated by a driver (not shown). Preferably a heat transfer medium circulator 63 is connected to the casting drum 32, so as to control a surface temperature to a predetermined value. The surface temperature is preferably in the range of −40° C. to +40° C. In this embodiment, passages of the heat transfer mediums are formed in the casting drum 32, and the heat transfer mediums whose temperature is controlled to the predetermined value is circulatory fed through the passages. Thus the temperature of the casting drum 32 is kept to a predetermined value.

Preferably, the casting drum 32 preferably rotates at high accuracy such that the rotation unevenness may be at most 0.2 mm. Further, the surface roughness of the casting drum 32 is preferably at most 0.01 μm. Further, a chrome plating is performed on the surface of the casting drum 32, such that the drum surface may have enough hardness and permanence. In this case, the surface defect of the casting drum 32 is reduced to be minimal. Concretely there are no pin hole of at least 30 μm, at most one pin hole of at least 10 μm and less than 30 μm, and at most two pin holes of less than 10 μm per 1 m².

In this embodiment, the casting drum 32 is used as a support. However, in the present invention, a casting belt supported by two back-up rollers may be used as the support. In this case, the back-up rollers preferably rotates at high accuracy such that the rotation unevenness may be at most 0.2 mm. Preferably, the surface defect of the casting belt 86 is reduced to be minimal. Concretely there are no pin hole of at least 30 μm, at most one pin hole of at least 10 μm and less than 30 μm, and at most two pin holes of less than 10 μm per 1 m².

The film production apparatus 20 includes a casting chamber 64 in which the casting die 31 and the casting drum 32 are provided and the casting of the casting dope 22 is made. In the casting chamber 64, there are a temperature controlling device 65 for controlling the inner temperature of the casting chamber 64 to the predetermined value, and a condenser 66 for condensing organic solvent evaporated in the casting chamber 64. Further a recovering device 67 for recovering the condensed organic solvent outside the casting chamber 64. Further, the dope discharged from the casting die 31 forms the bead 69b between the casting die 31 and the casting drum 32. In order control the pressure in an upstream side of a rotating direction X (or a running direction) of the casting drum 32 from the bead 69b, it is preferable to dispose a decompression chamber 68, as in this embodiment. Note that the casting dope 22 is peeled from the casting drum 32 and fed out as a film 82 from the casting chamber 64, about which the explanation will be made in detail later.

In a transfer area 80, there is an air blower 81. The edge slitting device 40 slits off both side edge portions of the film 82 into tips, and the tips of both side edge portions are crushed by a crusher connected to the edge slitting device 40.

In the drying chamber 41, there are many rollers 91, and provided with an adsorbing device 92 for adsorbing the solvent vapor generated by the evaporation of the solvent from the film 82. In the downstream from the drying chamber 41, the cooling chamber 42 is disposed. Between the drying chamber 41 and the cooling chamber 42, a humidity controller (not shown) may be provided. In the downstream from the cooling chamber 42, a compulsory neutralization device (or a neutralization bar) 93 eliminates the charged electrostatic potential of the film 82 to the predetermined value (for example, in the range of −3 kV to +3 kV). The position of the neutralization process is not restricted in this embodiment. For example, the position may be a predetermined position in the drying section or in the downstream side from a knurling roller 94, and otherwise, the neutralization may be made at plural positions. After the neutralization, the embossing of both side portions of the film 82 is made by embossing roller to provide the knurling. In the winding chamber 43, there is a winding shaft 95 for winding the film 82 and a press roller 96 for controlling the winding tension at the winding.

As shown in FIGS. 2 & 3, the bead 69b of the discharged casting dope 22 is formed between the casting die 31 and the casting drum 32. A position at which the bead 69b reaches the casting drum 32 to form the casting film 69 is called a casting position 69a. Among surfaces of the casting drum 32, a periphery of the drum 32, on which the casting film 69 is to be formed, is called a casting surface. In an upstream area from the bead 69b is disposed a decompression device 100 so as to be close to the casting die 31, the bead 69b and the casting drum 32.

A decompression device 100 is disposed in an upstream side from and near the casting position 69a. The decompression device 100 is constructed of the decompression chamber 68 partitioning from an outer side the space to be decompressed, an aspirator 117 for aspirating an air from an inside of the decompression chamber 68, and two aspiration pipes 101 (see, FIGS. 3 & 4) as passages of the air aspirated by the aspirator 117. The decompression chamber 68 has a ceiling plate 108 (see, FIGS. 3 & 4) which partitions the inside of the decompression chamber 68 from the outer space in upward, and the aspiration pipes 101 are disposed in both side of the ceiling plate 108.

As shown in FIG. 2, the decompression chamber 68 has an outer plate 102 so as to partition the inside of the decompression chamber 68 from the outer space in back side, and an inner plate 103 in parallel to the outer plate 102 apart at a slight distance. The inner plate 103 is shorter than the outer plate 102 in width, and there are edge inner plates 104 apart from both side edge of the inner plate 103. Each aspiration pipes 101 are connected to a space between the outer plate 102 and the edge inner plate 104, and the aspirated air passes from the inside of the decompression chamber 68 through the space between the inner plate 103 and the edge inner plate 104. Furthermore, the decompression chamber 68 is provided with air pipes 110-112 through the outer plate 102 and the inner plate 103. The air pipes 110-112 are connected to an air feeding device 116. Thus an air is supplied from the air feeding device 116 through the air pipes 110-112 into the decompression chamber 68. Note that a wind speed of the air is controlled as described later.

The decompression chamber 68 has an outer side plate 105 vertically disposed so as to extend in the rotating direction X and an partition plate 106 inside the outer side plate 105. The partition plate 106 is disposed at an inner end of the edge inner plate 104 and fixedly attached to an inner surface of the edge inner plate 104 with use of bracket or screw, so as to form a plate outer plate of the space to be decompressed. Each of the partition plate 106 is nearly trapezoid-shaped, and the edge thereof is almost in parallel to the casting die 31. Further, partition plates 107 are vertically disposed and fixedly attached to an inner surface of the inner plate 103 with use of bracket or screw, so as to extend in the rotating direction X. The partition plates 107 are nearly trapezoid-shaped, and an edge thereof is almost in parallel to the casting die 31. It is to be noted in this figure that the illustration of the partition plate 107 is omitted for simplicity.

As shown in FIG. 3, a packing 109 is attached to an inclined edge of the partition plates 106 so as to cover the front side of the space to be decompressed. The lower end of the packing 109 is closed to the die lip of the casting die 31, and there is an air inlet into the decompression chamber 68 under the lower end of the packing 109. Thus, when the decompression is made, the air between the bead 69b and the decompression chamber 68 can enter through the air inlet into the decompression chamber 68.

Further, the decompression chamber 68 is connected to a pressure gauge 115 for measuring an inner pressure of the decompression chamber 68.

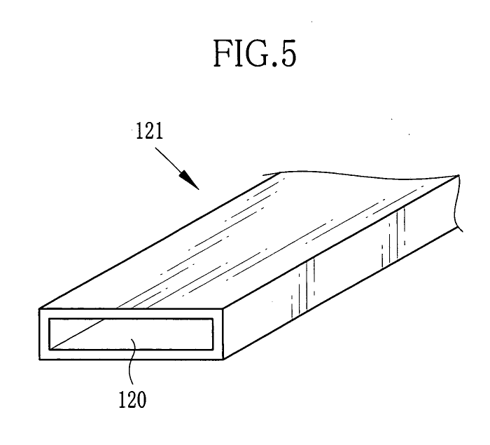

As shown in FIG. 4, in both side of the decompression chamber 68, the air pipes 110 and 111 are disposed between the partition plate 106 and the partition plate 107. Further, in a middle portion of the widthwise direction between the partition plates 107 of the decompression chamber 68, the air pipe 112 is disposed. Thus the pressure fluctuation in the decompression chamber 68 becomes uniform.

Especially, as the air pipe 112 in the middle area, a pipe having a slit-like outlet of the air may be used. Further, in the middle, the plurality of the air pipes may be arranged in the widthwise direction of the decompression chamber 68, and thus the effect for making the pressure fluctuation uniform becomes larger. Note in the present invention that the number and the position of the air pipes 110-112 are not restricted in this figure.

The shape the end of each air pipe 110-112 is not restricted especially. In this embodiment, the end of the air pipe has is circular. However, as shown in FIG. 5, an air pipe 121 to be used in the present invention may have an end 120 which is rectangular or slit-like. Preferably at least one of the air pipe 121 is used in the present invention. Especially, the air pipe 121 is used instead of the air pipe 112 in the middle portion in FIGS. 2&4.

Further, note that only one air pipe 112 is provided in the middle portion between the partition plates 107 in this embodiment. However, a plurality of the air pipes may be provided in the middle portion. Further, independently of the shape, a direction of the end of the air pipe is not restricted especially. As in this embodiment, the end of the air pipe is directed almost parallel to the rotating direction X. However, the end may be directed downwards, upwards, or oppositely to the rotating direction X. Especially, it is designated to direct the end downwards, upwards or oppositely to the rotating direction X, the air supplied into the decompression chamber 68 doesn't directly blow to the bead 69b. Therefore, the casting of the dope can be performed without decreasing the planarity of the produced film.

The positions of the ends of the air pipes 110-112 are not restricted especially. However, as shown in FIG. 3, the distance L1 from the end of each air pipe 110-112 to a lip end as an outlet of the casting die 31 is preferably in the range of 5 mm to 300 mm. Note that only the air pipe 110 is illustrated and the other air pipes 111, 112 are omitted for simplicity of the figure. If the distance L1 is smaller than 5 mm, the supplied air blows to the bead 69b of the casting dope 22 causes the deformation of the bead 69b, and otherwise the bead 69b vibrates such that the bead 69b has a scrape to the air pipes 110-112. Therefore, the default of the film production sometimes occurs. If the distance L1 is more than 300 mm, the effects of the present invention for reducing the pressure distribution cannot be expected enough. When it is designated to use a plurality of the air pipes, it is not necessary to always set the distance L1 to a same value between the used air pipes. The distance L1 may be adequately set in the range described above. Note that the effects of the present invention will be described in detail later.

In followings, a method of producing the film 82 with use of the film production apparatus 20 will be explained.

The casting dope 22 is always made uniform by rotating the stirrer 61. Also in the stirring, the additive (for example, plasticizer and the UV-absorbing agent and the like) can be mixed. The pump 62 is driven to feed the casting dope 22 to the filtration device 30, and then filtration is made. Thereafter the casting dope 22 is cast from the casting die 31 onto the casting drum 32 to form the casting film 69.

Preferably, the fluctuation of the speed of the casting drum 32 is at most 0.5% to the predetermined value. During the rotation of the casting drum 32, the meandering of the casting drum 32 in the widthwise direction occurs, and it is preferable that the meandering of the casting drum 32 rotating for one cycle is reduced in 1.5 mm. Further, below the casting die 31, it is preferable to control such that the variation of the position in the vertical direction between the lip end of the casting die 31 and the casting drum 32 may be in 200 μm. Further, the temperature in the casting chamber 64 is controlled in the range of −10° C. to 57° C. by the temperature controlling device 65. Note that the solvent vapor is recovered by the recovering device 67, and used as a solvent for preparing the dope after the refinement.

The casting dope 22 is cast from the casting die 31 onto the casting drum 32. Thus between the casting die 31 and the casting drum 32 is formed the bead 69b. At the casting, the temperature of the casting dope 22 is preferably controlled in the range of −10° C. to 57° C. Further, in order to stabilize the formation of the bead 69b of the discharged casting dope 22, the decompression chamber 68 controls the pressure in the upstream area from the bead 69b. The decompression is preferably made such that the pressure difference of an upstream to a downstream side in the rotating direction X from the bead 69b may be in the range of −10 Pa to −2000 Pa. It is preferable to provide the decompression chamber 68 with a jacket (not shown) for controlling the inner temperature. The temperature of the decompression chamber 68 is not restricted especially. However, the temperature is preferably at least the boiling point of the used organic solvent.

The air is supplied through the air pipes 110, 111 into both sides of the decompression chamber 68, and through the air pipe 112 to the middle portion of the width in the decompression chamber 68. Thus the pressure in the decompression chamber 68 becomes uniform in the widthwise direction, and the pressure fluctuation on time is reduced. Thus the formation of the bead 69b is not deformed, and the casting film 69 has an adequate surface condition. Further, since the air is supplied from the air pipes 110 and 111, it is prevented that the atmosphere enters from a lower portion of the outer wide plate 105. The air supplied through the air pipe 112 prevents the entrained air of the casting drum 32 as the support from entering into the decompression chamber 68. The supply volume rate of the air is not restricted especially. However, it is preferably in the range of 0.01 m³/min to 3 m³/min at room temperature and under atmospheric pressure. The adjustment of the supply volume rate of the air is made by a throttle valve (not shown) and the like. However, if the supply volume rate is less than 0.01 m³/min, it is sometimes hard to prevent the entrained air o from entering into the decompression chamber 68. If the supply volume rate is less than 3 m³/min, it is sometimes hard to prevent the atmosphere or the entrained air from entering into the decompression chamber. If the supply volume rate is more than 3 m³/min, it is sometimes hard to control the decompression degree inside the decompression chamber 68 into the predetermined value.

Further, the wind speed of the supplied air is preferably in the range of 0.1 m/s to 20 m/s. Thus the pressure fluctuation on time in the decompression chamber 68 is reduced such that the pressure distribution may be uniform. If the wind speed is less than 0.1 m/s, it is sometimes hard to make uniform the pressure. Further, in this case, it is sometimes hard to prevent the entrained air from entering into the decompression chamber 68. If the wind speed is more than 20 m/s, the supplied air blows to the bead 69b directly, and therefore the deformation of the bead 69b sometimes occurs.

Further, the pressure difference from the ordinary pressure to the pressure in the decompression chamber 68 is preferably in the range of 10 Pa to 2000 Pa. By using the aspiration pipe 101, the inner pressure of the decompression chamber 68 is made lower than the atmospheric pressure. In the present invention, since the air is supplied into the decompression chamber 68, the pressure fluctuation on time is reduced and the pressure control in the above range becomes possible. If the pressure difference from the ordinary pressure to the pressure in the decompression chamber 68 is more than 2000 Pa, the inner pressure in the upstream side from the bead 69b is too low, which sometimes causes the shape instability of the bead 69b and the rapid evaporation of the solvent from the bead 69b. If the pressure difference from the ordinary pressure to the pressure in the decompression chamber 68 is less than 10 Pa, it is sometimes difficult to expect the effect for making the shape of the bead 69b uniform. The inner pressure of the decompression chamber 68 is always measured by the pressure gauge 115, and on the basis of the measured data, the inner pressure of the decompression chamber 68 is controlled. Note that 1 atm is 1.013×10⁵ Pa.

When having self-supporting property, the casting film 69 is continuously peeled as the film 82 with support of a peel roller 75. The solvent content at the peeling is preferably in the range of 20 mass % to 350 mass % to the solid content. Then the film 82 is transported in the transfer area 80 in which many rollers are provided, and thus transported into the tenter device 35.

In the transfer area 80, while the film 82 is transported with the support of the pass rollers, a drying air is fed from the air blower 81 to dry the film 82, such that the drying may proceed. Preferably, the temperature of the drying air is in the range of 20° C. to 250° C. Note in the transfer area 80 that the rotating speed of the pass roller may be set to be higher in the downstream side, so as to draw the film 82.

During the transportation in the tenter device 35, the film 82 is held by clipping both side edge portions, and at the same time the drying is made to evaporate the solvent. The tenter device 35 is preferably partitioned into several temperature areas of different temperatures, such that the drying is made under different drying conditions of the respective temperature areas. At the same time, the stretching of the film 82 in the widthwise direction may be made. In this case, in the transfer area 80 or/and the tenter device 35, the stretching in the widthwise direction and the drawing in the lengthwise direction are made such that the width and the length may be in the range of 0.5% to 300% larger than the original size.

The film 82 is dried until the content of the remaining solvent become the predetermined value, and fed out from the tenter device 35 toward the edge slitting device 40 for slitting off both side edge portions. The slit side edge portions are sent to a crusher 90 by a cutter blower (not shown), and crushed to tips by the crusher 90. The tips are reused for preparing the dope, which is effective in view of the decrease of the production cost. Note that the slitting process of both side edge portions may be omitted. However, it is preferable to perform the slitting between the casting process and the winding process.

The film 82 whose side edge portions are slit off is sent to the drying chamber 41 and dried furthermore. In the drying chamber 41, the film 82 is transported with lapping on the rollers 91. The inner temperature of the drying chamber 41 is not restricted especially. However, it is preferable in the range of 50° C. to 160° C. The solvent vapor evaporated from the film 82 by the drying chamber 41 is adsorbed by the adsorbing device 92. The air from which the solvent components are removed is reused for the drying air in the drying chamber 41. Note that the drying chamber 41 preferably has plural partitions for variation of the drying temperature. Further, a pre-drying device (not shown) is provided between the edge slitting device 40 and the drying chamber 41, so as to perform the pre-drying of the film 82. Thus it is prevented that the temperature of the film 82 increases rapidly, and therefore the change of the shape of the film 82 is reduced.

The film 82 is transported into the cooling chamber 42, and cooled therein nearly to the room temperature. A humidity control chamber (not shown) may be provided for conditioning the humidity between the drying chamber 41 and the cooling chamber 42. Preferably, in the humidity control chamber, an air whose temperature and humidity are controlled is applied to the film 82. Thus the curling of the film 82 and the winding defect in the winding process can be reduced.

Thereafter, a compulsory neutralization device (or a neutralization bar) 93 eliminates the charged electrostatic potential of the film 82 to the predetermined value (for example, in the range of −3 kV to +3 kV). The position of the neutralization process is not restricted in this embodiment in which the neutralization process is disposed in downstream from the cooling chamber 42 as in FIG. 1. Further, the knurling roller 94 may be provided for make the knurling by embossing of both side portions of the film 82. The emboss height from the bottom to the top of the embossment is preferably in the range of 1 μm to 200 μm.

In the last process, the film 82 is wound by the winding shaft 95 in the winding chamber 56. At this moment, a tension is applied at the predetermined value to the press roller 96. Preferably, the tension is gradually changed from the start to the end of the winding. In the present invention, the length of the film 82 is preferably at least 100 m. The width of the film is preferably at least 600 mm, and particularly in the range of 1400 mm to 1800 mm. Further, even if the width is more than 1800 mm, the present invention is effective. When it is designated to produce the film which is 15 μm to 100 μm in thickness, the present invention is also applied.

In the solution casting method of the present invention, there are casting methods for casting plural dopes, for example, a co-casting method and a sequential casting method. In the co-casting method, the feed block may be attached to the casting die 31 as in this embodiment, or a multi-manifold type casting die (not shown) may be used. In the film of multi-layer structure, at least one of the thickness of the peeled layer (lowermost layer) from the support and that of the opposite layer (uppermost layer) thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers (namely lower- and uppermost layers) have lower viscosity than the dope for forming a layer (intermittent layer) sandwiched by the surface layers. Further, when the co-casting is designated, it is preferable in the bead between die slit and the support that the composition of alcohol is higher in the two outer dopes than the inner dope.

Japanese Patent Laid-Open Publication No. 2005-104148 describes from [1073] to [1087] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

These functional layers preferably contain at least one sort of surfactants in the range of 0.1 mg/m² to 1000 mg/m². Further, the functional layers preferably contain at least one sort of lubricants in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

Conditions and Methods for forming the functional layer are described in detail from [0890] to [1072] of Japanese Patent Laid-Open Publication No. 2005-104148, which can be applied to the present invention. Thus, the produced film can have several functions and properties.

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses from [1088] to [1265] the liquid crystal displays of TN type, STN type, VA type, OCB type, reflective type, and other types in detail. The description may be applied to the present invention.

Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the Laid-Open Publication No. 2005-104148 continues from [1088] to [1265], which can be applied to the present invention.

### EXPERIMENT

According to the present invention, an experiment was made. In followings, examples and comparisons of the experiment will be described.

(Composition)

| | | |
|---|---|---|
| Cellulose Triacetate | 100 | pts. mass |
| (Powder: degree of substitution, 2.84; viscosity- | | |
| average degree of polymerization, 306; water | | |
| content, 0.2 mass %; viscosity of 6 mass % | | |
| dichloromethane solution, 315 mPa · s; | | |
| averaged particle diameter, 1.5 mm; standard | | |
| deviation of particle diameter, 0.5 mm) | | |
| Dichloromethane (first solvent compound) | 320 | pts. mass |
| Methanol (second solvent compound) | 83 | pts. mass |
| 1-butanol (third solvent compound) | 3 | pts. mass |
| Plasticizer A (triphenylphosphate) | 7.6 | pts. mass |
| Plasticizer B (diphenylphosphate) | 3.8 | pts. mass |
| UV-agent A | 0.7 | pts. mass |
| (2(2′-hydroxy-3′,5′-di-tert-butylphenyl)benzotriazol) | | |
| UV-agent B | 0.3 | pts. mass |
| (2(2′-hydroxy-3′,5′-di-tert-amylphenyl)-5- | | |
| chlorobenzotriazol) | | |
| Mixture of citric acid esters | 0.006 | pts. mass |
| (Mixture of citric acid, citric acid monoethyl ester, | | |
| citric acid dimethyl ester, citric acid triethyl ester) | | |
| Particles | 0.05 | pts. mass |
| (particle diameter, 15 nm; Mohs Hardness, about 7) | | |

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton, and called cotton TAC in the following explanation.

The film 82 was produced with use of the film production apparatus 20 of FIG. 1. At first, the casting dope 22 was produced from the above raw materials and stored in the stock tank 21 produced of stainless. The pump 62 was driven to feed the casting dope 22 from the stock tank 21 to the filtration device 30 to make the filtration, and then the dope was fed to the casting die 31.

The width of the casting die 31 was 1.8 m, The flow volume rate of the casting dope 22 near a die lip of the casting die 31 is controlled such that the dried film may be 80 μm in thickness. The casting width of the casting dope 22 from the die lip was 1700 mm. The casting speed was 80 m/min. Further, in order to control the temperature of the casting dope 22 to 36° C., the temperature of the heat transfer medium at an entrance of the jacket (not shown) was 36° C.

In the upstream side from the casting die 31, the decompression chamber 68 is disposed. The decompression rate of the decompression chamber 68 was controlled in accordance with the casting speed, such that the pressure difference might occur in the range of one Pa to 5000 Pa between the upstream and downstream sides from the bead 69b of the discharged casting dope 22 above the casting die 31. At this time, the pressure difference between both side of the bead 69b of the discharged casting dope 22 was determined such that the length of the bead 69b might be from 20 mm to 50 mm. Further, an apparatus was provided such that the temperature of the decompression chamber 68 might be set to be higher than the condensation temperature of the gas around the casting section. Further, there were labyrinth packings (not shown) in the upstream and downstream sides of the bead 69b. Further, an opening was provided in both edges. Further, an edge suctioning device (not shown) for reducing the disturbance of the bead 69b was provided.

As shown in FIG. 4, the decompression chamber 68 was provided with three air pipes 110-112. The distances L1 from the ends of the air pipes 110-112 to the casting die 31 was 30 mm, 30 mm and 70 mm. The wind speeds of the air from the air pipes 110-112 were respectively in the range of 2.0 to 2.2 m/min, 2.0-2.2 m/min, and 1.5-1.7 m/min. At this time, the pressure difference from the ordinary pressure to the pressure inside the decompression chamber 68 was kept in the range of 515 Pa to 510 Pa.

The casting drum 32 used as the support was produced of SUS 316, and the casting dope 22 was cast from the casting die 31 onto the casting drum 32 to form the casting film 69. The temperature in the casting chamber 64 was kept to 35° C. by the temperature controlling device 65, and the solvent vapor in the casting chamber 64 was condensed for recovery by the condenser 66 at whose exit the temperature was set to −10° C.

When having the self-supporting properties, the casting film 69 was peeled as the film 82 from the casting drum 32 with support of the peel roller 75. The film 82 was transported with the rollers in the transfer area 80 toward the tenter device 35. In the transfer area 80, the drying air at 40° C. was fed out from the air blower 81 toward the film 82, and the tension about 30 N was applied to the film 82 in the lengthwise direction.

In the tenter device 35, while both side edge portions of the film 82 are held by clips, the stretch of the film 82 in the widthwise direction was made with the transportation, and the drying of the film 82 was made with use of the drying air. Thereafter, the both side edge portions of the film 82 were slit off by the edge slitting device 40, and then the film 82 was sent to the drying chamber 41. The drying chamber 41 incorporates many rollers 91 made of aluminum or carbon steel, and the hard chrome coating was made on the surface of each roller 91. The high temperature drying was made with winding the film 82 around the rollers 91.

After the drying, the film 82 was transported into a moisture controlling chamber (not shown) to control the moisture of the film 82, and then transported into the cooling chamber 42 to cool the film 82. In the transportation, the charged electrostatic potential of the film might be controlled in the range of −3 kV to +3 kV by the compulsory neutralization device (or a neutralization bar) 93. Further, the film knurling was made on a surface of each side of the film 82 by the knurling roller 94. The film 82 was transported to the winding chamber 43 and wound around the winding shaft 95 to a film roll.

The obtained film roll of the film 82 was observed with eyes to make the visual examination, in which the loose winding and wrinkles didn't occur and the roll appearance was excellent. Further, the 10 G impact test was made, in which the film didn't transit in the film roll.

The film roll of the film 82 is stored in the storing rack of 55% RH at 25° C. for one month. Then the inspection was made in the same way as above, but the remarkable change of the film conditions was not recognized. Further, the adhesion of the film didn't occur in the film roll.

During the production of the film 82, it was observed whether any part of the film 82 might remain on the casting drum 32. As the result, nothing was observed according to the remaining part. Further, the film 82 was checked with eyes, and the film surface was extremely smooth and there were neither thickness unevenness nor foreign materials.

### Example 2

In Example 2, only the air pipe 112 was provided for the decompression chamber 68, and the air pipes 110, 111 were removed. Other conditions were the same as Example 1. As the result, the surface of the film 82 was smooth, and the thickness unevenness almost didn't occur.

### Example 3

In Example 3, only the air pipes 110, 111 were provided for the decompression chamber 68, and the air pipe 112 was removed, and a hole at the portion of removal of the air pipes 112 was stopped. Other conditions were the same as Example 1. As the result, the surface of the film 82 was smooth, and the thickness unevenness almost didn't occur.

### Example 4

In Example 4, the air pipe 121 having the slit-like end was provided for the middle portion of the decompression chamber 68, and the air pipes 110, 111 having the tube-like end were provided for both side of the decompression chamber 68. Other conditions were the same as example 1. As the result, the surface of the film 82 was smooth and the thickness unevenness almost didn't occur.

### Example 5

In Example 5 as comparison, all of the air pipes 110-112 were removed, and holes at the portions of removal of the air pipes 110-112 were stopped. Other conditions were the same as Example 1. As the result, although the surface of the film 82 was smooth, the thickness unevenness occurred.

Various changes and modifications are possible in the present invention and may be understood to be within the present invention.

What is claimed is:

1. An apparatus for producing a film, comprising:
a casting die for continuously casting on a support a dope containing a polymer and a solvent so as to form a casting film, said dope forming a bead between said die and said support;
a decompression chamber disposed in an upstream side of a running direction of said support from said bead so as to be close to said bead, said decompression chamber decompressing an upstream area from said bead along a width of said bead;
an air supplier for supplying an air into said decompression chamber such that an airflow in said decompression chamber may be uniformed; and
a drying device for drying said casting film after being peeled from said support.

2. An apparatus described in claim 1,
wherein said decompression chamber has a main body partitioning an space to be decompressed from an outside and an aspirating section for aspirating an inner air in said inner space, and
wherein said air supplier has an pipe for guiding said air into said inner space.

3. An apparatus described in claim 2, wherein said pipe is at least one of a first pipe disposed in a middle portion of a widthwise direction of said main body and a second pipe disposed in a side portion of said widthwise direction of said main body.

4. An apparatus described in claim 3, wherein each of said first and second pipes has an air outlet of slit-like shape or a circular shape in cross section.

5. An apparatus described in claim 4, wherein a distance L1 from said air outlet to a lip end of said casting die is in the range of 5 mm to 300 mm.

6. An apparatus described in claim 2, wherein a supply volume rate of said air is in the range of 0.01 m³/min to 3 m³/min.

7. An apparatus described in claim 6, wherein a flow speed of said air is 0.1 m/s to 20 m/s.

8. An apparatus described in claim 7, wherein when a pressure in a downstream area of said running direction of said support from said bead is PD, a pressure in said upstream area is almost constant in the range of (PD-2000) Pa to (PD-10) Pa.

9. An apparatus described in claim 8, wherein said polymer is cellulose acylate.

10. A method of producing a film, comprising steps of:
continuously casting from a casting die onto a support a dope containing a polymer and a solvent so as to form a casting film, said dope forming a bead between said die and said support;
decompressing an upstream area from said bead by a decompression chamber, such that a pressure in said upstream area may be smaller than in a downstream area from said bead, said decompression chamber having a main body for partitioning an space to be decompressed from an outside;
supplying an air into said main body during the decompressing, so as to uniform a pressure in a widthwise direction of said bead;
peeling said casting film as a film from said support; and
drying said film.

11. A method described in claim 10, wherein a wind speed of said air to be supplied is in the range of 0.1 m/s to 20 m/s.

12. A method described in claim 11, wherein a supply volume rate of said air is in the range of 0.01 m³/min to 3 m³/min.

13. A method described in claim 11, wherein when a pressure in said downstream area is PD, a pressure in said upstream area is almost constant in the range of (PD-2000)Pa to (PD-10)Pa.

14. A method described in claim 11, wherein said air is supplied into a middle portion in a widthwise direction of said main body.

15. A method described in claim 10,
wherein said decompression chamber has an aspirating section for aspirating an inner air in said main body, and
wherein said air is guided from said air supplier through an pipe into said main body.

16. A method described in claim 15, wherein said pipe is at least one of a first pipe disposed in a middle portion of a widthwise direction of said main body and a second pipe disposed in a side portion of said widthwise direction of said main body.

17. A method described in claim 16, wherein each of said first and second pipes has an air outlet of slit-like shape or a circular shape in cross section.

18. A method described in claim 17, wherein a distance L1 from said air outlet to a lip end of said casting die is in the range of 5 mm to 300 mm.

19. A method described in claim 18, wherein said polymer is cellulose acylate.
